(19) United States
(12) Patent Application Publication
(10) Pub. No.: US 2026/0197227 A1
(43) Pub. Date: Jul. 9, 2026

(54) AUTOMATED DIAGNOSTIC AND PREDICTIVE TROUBLESHOOTING

(71) Applicant: CenturyLink Intellectual Property LLC, Denver, CO (US)

(72) Inventors: Shaun HAWKINSON, St. Paul, MN (US); Kevin LU, Bridgewater, NJ (US)

(73) Assignee: CenturyLink Intellectual Property LLC, Denver, CO (US)

(21) Appl. No.: 19/442,203

(22) Filed: Jan. 7, 2026

Related U.S. Application Data
(60) Provisional application No. 63/742,711, filed on Jan. 7, 2025.

(51) Int. Cl. H04L 41/0654; H04L 41/0631

(52) U.S. Cl. CPC H04L 41/0654; H04L 41/064

(57) ABSTRACT

Novel tools and techniques are provided for implementing automated diagnostic and predictive troubleshooting. In examples, a framework engine identifies an issue(s) associated with CPE, network services, and/or network equipment, based on analysis of network data collected from a plurality of data sources that monitor a plurality of CPE, a plurality of network services, and a plurality of network equipment within a network(s). An actions engine determines next best actions (“NBAs”) to resolve the issue(s). In some examples, the framework engine causes an automation workflow engine to perform at least one automation workflow. If the issue(s) has not been resolved, the framework engine generates and sends a message to a user device indicating an unresolved issue(s) including relevant information and the NBAs. If the current and/or predicted issue(s) has been resolved, the framework engine generates and sends another message to the user device indicating that the issue(s) has been resolved.

### CROSS-REFERENCE TO RELATED APPLICATIONS

This application claims the benefit of U.S. Provisional Application No. 63/742,711 filed Jan. 7, 2025, entitled “Automated Diagnostic and Predictive Troubleshooting,” which is incorporated herein by reference it its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing automated diagnostic and predictive troubleshooting.

### BACKGROUND

In existing telecommunications systems, diagnostics and troubleshooting is typically performed manually. Automated diagnostic and troubleshooting processes are typically unable to provide end-to-end network view, due in large part by disparate and/or siloed platforms either separating customer access, service provider agent access, and/or technician access, or separating customer premises equipment (“CPE”)-connected networks, network services, and/or network equipment-connected networks, or both. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing automated diagnostic and predictive troubleshooting, in accordance with various embodiments.

FIGS. 2A and 2B depict example sequence flows for obtaining data via a pull model and via a push model when implementing automated diagnostic and predictive troubleshooting, in accordance with various embodiments.

FIGS. 3A-3C depict various example sequence flows corresponding to various example implementations for automated diagnostic and predictive troubleshooting, in accordance with various embodiments.

FIGS. 4A-4C depict flow diagrams illustrating an example method for implementing automated diagnostic and predictive troubleshooting, in accordance with various embodiments.

FIG. 5 depicts a flow diagram illustrating another example method for implementing automated diagnostic and predictive troubleshooting, in accordance with various embodiments.

FIG. 6 depicts a block diagram illustrating an exemplary computer or system hardware architecture, in accordance with various embodiments.

### DETAILED DESCRIPTION OF CERTAIN EMBODIMENTS

### Overview

Today, the in-home support ecosystem utilizes various disparate support systems and platforms that are developed separately, have different release schedules, use different algorithms for troubleshooting, have different diagnostic thresholds, and provide no end-to-end network view.

The present technology provides for automated diagnostic and predictive troubleshooting. In examples, a computing system collects, in a data repository (e.g., a data lake, etc.), network data (e.g., end-to-end (“E2E”) network data or other network data, etc.) from a plurality of data sources that monitor a plurality of CPE, a plurality of network services, and a plurality of network equipment within one or more networks. A framework engine of the computing system identifies a current and/or predicted issue(s) associated with at least one of one or more CPE, one or more network services, and/or one or more network equipment, based on analysis of the network data. An actions engine of the computing system determines one or more next best actions (“NBAs”) to resolve the current and/or predicted issue(s). In some examples, the framework engine causes an automation workflow engine to perform at least one automation workflow as part of the one or more NBAs. If the current and/or predicted issue(s) has not been resolved, the framework engine generates and sends a message to a user device associated with a user indicating an unresolved issue(s) including relevant information and the one or more NBAs. If the current and/or predicted issue(s) has been resolved, the framework engine generates and sends another message to the user device indicating that the current and/or predicted issue(s) has been resolved.

These and other aspects of the automated diagnostic and predictive troubleshooting are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values, etc.).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Aspects of the present invention, for example, are described below with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

In an aspect, the technology relates to a method, including: collecting, by a computing system and in a data repository, network data from a plurality of data sources, the network data including near-real-time data and historical data associated with at least network equipment, network services, and CPE within one or more networks; identifying, by a framework engine of the computing system, a first issue associated with at least one of one or more network equipment, one or more network services, or one or more CPE being provided within the one or more networks, based on analysis of the network data, wherein the first issue is one of a current issue or a predicted issue; determining, by an actions engine of the computing system, one or more NBAs to resolve the first issue; determining, by the framework engine, whether at least one NBA among the one or more NBAs can be performed using an automation workflow engine; based on a determination that at least one NBA among the one or more NBAs can be performed using at least one automation workflow, causing, by the framework engine, the automation workflow engine to perform the at least one automation workflow, with the automation workflow engine generating and using automated scripts tailored to at least partially resolve the first issue; based on either a determination that the one or more NBAs cannot be performed using an automation workflow or a determination that the at least one automation workflow has not resolved the first issue, generating and sending, by the framework engine, a first message to a user device associated with a user, the first message including information regarding the first issue, an indication that the first issue is yet to be resolved, and a list of remaining NBAs among the one or more NBAs; and based on a determination that the first issue has been resolved, generating and sending, by the framework engine, a second message to the user device, the second message including the information regarding the first issue and an indication that the first issue was identified and has been resolved.

In another aspect, the technology relates to a system, including a data repository, a framework engine, and an actions engine. The system executes computer executable instructions that cause the system to perform operations including: collecting, in the data repository, network data from a plurality of data sources, the network data including near-real-time data and historical data associated with at least network equipment, network services, and CPE within one or more networks; identifying, using the framework engine, a first issue associated with at least one of one or more network equipment, one or more network services, or one or more CPE being provided within the one or more networks, based on analysis of the network data, wherein the first issue is one of a current issue or a predicted issue; determining, using the actions engine, one or more NBAs to resolve the first issue; determining, using the framework engine, whether at least one NBA among the one or more NBAs can be performed using an automation workflow engine; based on a determination that at least one NBA among the one or more NBAs can be performed using at least one automation workflow, causing, using the framework engine, the automation workflow engine to perform the at least one automation workflow, with the automation workflow engine generating and using automated scripts tailored to at least partially resolve the first issue; based on either a determination that the one or more NBAs cannot be performed using an automation workflow or a determination that the at least one automation workflow has not resolved the first issue, generating and sending, using the framework engine, a first message to a user device associated with a user, the first message including information regarding the first issue, an indication that the first issue is yet to be resolved, and a list of remaining NBAs among the one or more NBAs; and based on a determination that the first issue has been resolved, generating and sending, using the framework engine, a second message to the user device, the second message including the information regarding the first issue and an indication that the first issue was identified and has been resolved.

In yet another aspect, the technology relates to a method, including: identifying, by a framework engine of a computing system, at least one of characteristics or patterns in network data that are indicative of a user performing user-initiated actions, the network data including near-real-time data and historical data associated with at least network equipment, network services, and CPE within one or more networks; identifying, by the framework engine, at least one of one or more network equipment, one or more network services, or one or more CPE within the one or more networks that are either related to or potentially affected by the user-initiated actions; analyzing, by the framework engine, network data associated with the at least one of the one or more network equipment, the one or more network services, or the one or more CPE that are either related to or potentially affected by the user-initiated actions; identifying, by the framework engine, a first issue based on the analysis of the network data associated with the at least one of the one or more network equipment, the one or more network services, or the one or more CPE; determining, by an actions engine of the computing system, one or more NBAs to resolve the first issue; performing at least one of: (i) causing, by the framework engine, an automation workflow engine to perform at least one automation workflow as part of the one or more NBAs; or (ii) generating and sending, by the framework engine, a first message to a user device associated with the user, the first message including information regarding the first issue, an indication that the first issue is yet to be resolved, and a list including the one or more NBAs; and based on a determination that the first issue has been resolved, generating and sending, by the framework engine, a second message to the user device, the second message including the information regarding the first issue and an indication that the first issue was identified and has been resolved.

Various modifications and additions can be made to the embodiments discussed herein without departing from the scope of the invention. For example, while the embodiments described above refer to particular features, the scope of this invention also includes embodiments having different combinations of features and embodiments that do not include all of the above-described features.

### Specific Exemplary Embodiments

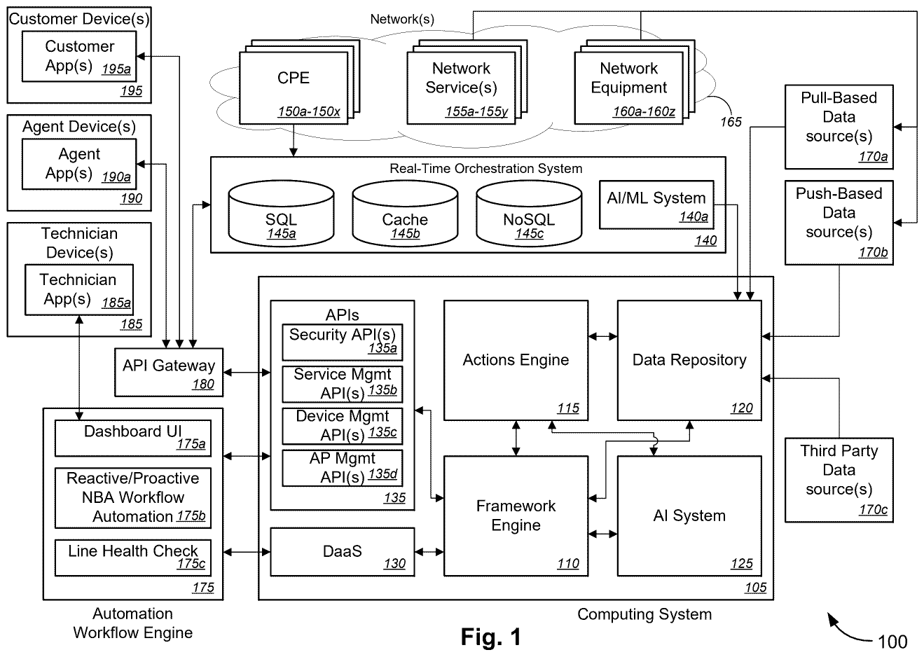

Turning to the embodiments as illustrated by the drawings, FIG. 1-6 illustrate some of the features of methods, systems, and apparatuses for implementing automated diagnostic and predictive troubleshooting, as referred to above. The methods, systems, and apparatuses illustrated by FIGS. 1-6 refer to examples of different embodiments that include various components and steps, which can be considered alternatives or which can be used in conjunction with one another in the various embodiments. The description of the illustrated methods, systems, and apparatuses shown in FIGS. 1-6 is provided for purposes of illustration and should not be considered to limit the scope of the different embodiments.

With reference to the figures, FIG. 1 depicts an example system 100 for implementing automated diagnostic and predictive troubleshooting, in accordance with various embodiments.

In the non-limiting example of FIG. 1, system 100 includes a computing system 105 that performs automated diagnostic and predictive troubleshooting. In some examples, the computing system 105 includes a framework engine 110, an actions engine 115, a data repository 120 (e.g., a data lake or the like), an artificial intelligence (“AI”) system 125, a Diagnostics as a Service (“DaaS”) system 130, and application programming interfaces (“APIs”) 135. In examples, the APIs 135 may include security API(s) 135a corresponding to security-based data or to portions of the data repository 120 corresponding to security-based data sources, service management API(s) 135b corresponding to service management-based data or to portions of the data repository 120 corresponding to service management-based data sources, device management API(s) 135c corresponding to device management-based data or to portions of the data repository 120 corresponding to device management-based data sources, and/or access point (“AP”) management API(s) 135d corresponding to AP management-based data or to portions of the data repository 120 corresponding to AP management-based data sources, and/or the like. System 100 further includes a real-time orchestrator (“RTO”) system 140, which may include an artificial intelligence/machine learning (“AI/ML”) system 140a, a structured query language (“SQL”) or relational data store 145a, a cache 145b (e.g., a remote dictionary server (“Redis”) storage system that functions as a cache or as a primary database, or the like), and a non-relational data store 145c (e.g., a not only SQL (“NoSQL”) data store, etc.).

System 100 further includes a plurality of CPE 150a-150x (collectively, “CPE 150,” or the like), a plurality of network services 155a-155y (collectively, “network services 155,” or the like), and a plurality of network equipment 160a-160z (collectively, “network equipment 160,” or the like), in one or more networks 165. Herein, x, y, and z are non-negative integer numbers that may be either all the same as each other, all different from each other, or some combination of same and different (e.g., one set of two or more having the same values with the others having different values, a plurality of sets of two or more having the same value with the others having different values, etc.).

In examples, the plurality of CPE 150a-150x may include devices associated with or assigned to a plurality of customers, each device providing connectivity to one or more networks 165 through which network services are provided to the plurality of customers. In some examples, the devices may include telephones, routers, network switches, gateways (e.g., residential gateways, commercial gateways, Internet access gateways, etc.), set-top boxes, home networking adapters, modems, etc. In examples, the plurality of network services 155a-155y may include Internet services (e.g., cloud networking, dedicated Internet access, etc.), Ethernet services, virtual private network (“VPN”) services (e.g., Internet protocol (“IP”) VPN services, etc.), voice services (e.g., voice over Internet protocol (“VoIP”) services, 9-1-1 services, specialty line services, session initiation protocol (“SIP”) trunking services (for VoIP connectivity between on-premises phone systems and the public switched telephone network (“PSTN”)), etc.), networking services (e.g., integrated networking solutions designed to decrease latency, to strengthen security, and to enable scalability, etc.; software-defined wide area network (SD-WAN”) services; etc.), network security services (e.g., secure access service edge (“SASE”) services, firewall services, distributed denial-of-service (“DDoS”) mitigation and protection services, malware-detection services, etc.), and/or the like. In some examples, the plurality of network equipment 160a-160z may include switches, routers, hubs, bridges, gateways, multiplexers and demultiplexers, transceivers, servers, firewalls, modems, repeaters, access points, etc.

According to some embodiments, network(s) 165 may each include, without limitation, one of a local area network (“LAN”), including, without limitation, a fiber network, an Ethernet network, a Token-Ring™ network, and/or the like; a wide-area network (“WAN”); a wireless wide area network (“WWAN”); a virtual network, such as a VPN; the Internet; an intranet; an extranet; a PSTN; an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network(s) 165 may include an access network of the service provider (e.g., an Internet service provider (“ISP”)). In another embodiment, the network(s) 165 may include a core network of the service provider and/or the Internet.

System 100 further includes a plurality of data sources 170, including one or more pull-based data sources 170a, one or more push-based data sources 170b, and one or more third party (or external) data sources 170c. In some examples, the one or more pull-based data sources 170a are data sources from which data is requested or pulled, and may include a customer relationship management (“CRM”) platform, a line provisioning platform, an operations support system and business support system (“OSS/BSS”) integrated platform and its network inventory management system, a wireless access point manager, a dispatch system, and/or a media access control (“MAC”) address tracking platform, and/or the like. In examples, the one or more push-based data sources 170b are data sources that push event data to subscribers of the event data, and may include an automatic configuration server, a log for optical line terminals (“OLTs”) and/or for optical network terminals (“ONTs”), an alarm system, a logistics inventory system, and a remote authentication dial-in user service (“RADIUS”)-based system. In some examples, the one or more third party data sources 170c are data sources owned, managed, and/or operated by third parties related to data that is tangential to network services or network service provisioning, and may include a real-estate marketplace platform, an organizational unique identifier (“OUI”) lookup database, a Wi-Fi certification database, or a modulation and coding scheme (“MCS”) index, and/or the like.

The CRM platform is used to manage (and store) customer relations data including customer billing records, dispatches, contacts, open cases, complaints, payment information, etc., and serves as a source of the customer relations data. The line provisioning platform is configured to provision line services including walled gardens, passive optical network (“PON”)-based implementations, etc., and serves as a source of data regarding such line services (e.g., line data, walled garden restrictions and limitations, network information, etc.). The OSS/BSS integrated platform is configured to provide service order management, activation, provisioning, and inventory management of fiber and copper plant inventory for multiple types of wireline and wireless networks, while its network inventory management system enables automated flow-through provisioning of copper, fiber, wireless, and hybrid networks. The OSS/BSS integrated platform and its network inventory management system serve as sources of data for the inventory of equipment for provisioning of copper, fiber, wireless, and hybrid networks (e.g., equipment information, connectivity information, equipment order information, status information, connectivity information, etc.). The wireless access point manager is configured to manage Wi-Fi access points and/or other wireless access points (“WAPs”), and serves a source of data regarding such access points (e.g., device information, status information, connectivity information, etc.). The dispatch system enables dispatch of technicians to customer premises, and serves as a source of data regarding such dispatches (e.g., service to be performed, location of service, status of service before and after dispatch, line data before and after dispatch, etc.). The MAC address tracking platform is configured to track a history of MAC addresses on the one or more networks, and serves as a source of data related to current and historical data associated with the tracked history of MAC addresses.

The automatic configuration server manages modems and receives phone-home messages once or twice a day from each modem, and serves as a data source that pushes data regarding when particular modems phone home or fail to phone home. The log for OLTs and/or for ONTs track status and connectivity between OLTs (at a central office) and ONTs (at customer premises), and serves as a data source that pushes status change data and/or connectivity change data regarding particular OLTs and/or ONTs. The alarm system monitors alarms that are triggered in the one or more networks 165, and serves as a data source that pushes alarm data when alarms are triggered. The logistics inventory system tracks serial numbers of inventory equipment, and serves as a data source that pushes inventory change information when changes in terms of equipment in the inventory or location of equipment occur. The RADIUS-based system provides centralized authentication, authorization, and accounting management services for users who connect and use a network service, and serves as a data source that pushes data associated with when a network service session is lost or rendered offline and/or when a network service session is established or restored.

The real-estate marketplace platform provides real-estate marketplace services for sale and rent of residential and/or commercial real-estate, and serves as a data source for premises data associated with residential and commercial premises. In some examples, the premises data includes at least one of dimension data, feature data, structural data, construction date data, location data, or neighborhood data associated with the residential and commercial premises, and/or the like. The OUI lookup database stores device manufacturer data associated with each network device connected to the one or more networks 165. The Wi-Fi certification database stores Wi-Fi certification data for Wi-Fi devices connected to the one or more networks 165. The MCS index stores MCS data associated with wireless network devices connected to the one or more networks. In examples, the MCS data includes at least one a list of modulation schemes, a list of coding schemes, wireless device transmission capability data, or wireless device transmission characteristics and behavior, and/or the like. Although particular examples of data sources 170a-170c and their particular uses are described above, other data sources may be additionally and/or alternatively used, and these particular uses and other uses of data sources 170a-170c and/or other data sources may be implemented consistent with the scope of the various embodiments.

System 100 further includes an automation workflow engine 175, which may include a dashboard user interface (“UI”) 175a, a reactive and/or proactive NBA workflow automation system 175b, and/or a line health check system 175c, and/or the like. System 100 further includes an API gateway 180, a technician device(s) 185 associated with a technician(s) or field technician(s), an agent device(s) 190 associated with an agent(s) of the service provider (e.g., a call center agent(s), a store representative(s), etc.), and/or a customer device(s) 195 associated with a customer(s), and/or the like. In examples, the technician device(s) 185 has a technician app(s) 185a running thereon that interacts with the automation workflow engine 175 via dashboard UI 175a. In some instances, the agent device(s) 190 has an agent app(s) 190a running thereon. Similarly, the customer device(s) 195 has a customer app(s) 195a running thereon. The agent app(s) 190a and/or the customer app(s) 195a each interacts with the computing system 105 via API gateway 180 and APIs 135, and/or interacts with the RTO system 140 via API gateway 180. In examples, the RTO system 140 interacts with the computing system 105 via API gateway 180 and APIs 135.

In some aspects, the RTO system 140 collects (and in some cases, aggregates) real-time and historical data sent by the plurality of CPE 150a-150x within the one or more networks 165. In some examples, cache 145b, when implemented using a Redis storage system, is used to store a digital twin of the real-time data collected from the plurality of CPE 150a-150x, while raw changes (i.e., deltas) in data collected from the plurality of CPE 150a-150x are stored in the relational (e.g., SQL) data store 145a, and historical data (e.g., several days'worth, a week's worth, or more of historical data) is stored in the non-relational (e.g., NoSQL) data store 145c. The AI/ML system 140a of the RTO system 140 uses an ML model to generate status and alert data based on the real-time and historical data sent by the plurality of CPE 150a-150x and stored in data stores 145a-145c. The computing system 105 collects, in data repository 120, the status and alert data generated by the ML model of the RTO system 140 as real-time data, near-real-time data, and/or historical data associated with the plurality of CPE 150. The pull-based data source(s) 170a and/or the push-based data source(s) 170b each collects real-time, near-real-time, and/or historical data associated with the plurality of network services 155a-155y and/or associated with the plurality of network equipment 160a-160z. The computing system 105 pulls or requests the data from the pull-based data source(s) 170a and stores in data repository 120, and subscribes to event data that are pushed from the push-based data source(s) 170b into the data repository 120. The data from the third party data source(s) 170c are either pulled, pushed, or requested from the third party data source(s) 170c for storage in the data repository 120. In this manner, the data repository 120 collects network data including real-time data, near-real-time data, and historical data that each includes at least one of status data, operational data, log data, connectivity data, failure data, equipment data, inventory data, network data, service data, customer service records, service location data, or E2E network data, and/or the like. As used herein, “real-time data” may refer to data that corresponds to current data within about one or two seconds or less from the time it is initially monitored or sensed, while “near-real-time data” may refer to almost current data that is between about three seconds and about one or two minutes from the time it is initially monitored or sensed, while historical data may refer to data that is longer than about two minutes from the time it is initially monitored or sensed.

In examples, the framework engine 110 analyzes the network data stored in the data repository 120, in some cases, using the AI system 125, and identifies patterns, characteristics, and/or trends that are indicative of user-initiated actions, network security issues, non-optimal operations issues, and/or the like, in some instances, based on the analysis. In some cases, the framework engine 110 iterates the analysis and/or focuses its analysis on such indications (e.g., in a drill-down mode) to further identify whether there are issues (or other issues) with the network service(s), the network equipment, and/or the CPE. The actions engine 115 determines NBAs to resolve the issue(s) identified by the framework engine 110, in some cases, using the AI system 125 and/or additional network data from the data repository 120. The framework engine 110 determines whether any of the NBAs can be performed using an automation workflow, and, if so, directs DaaS system 130 to instruct the automation workflow engine 175 to perform at least one automation workflow to at least partially resolve the identified issue(s). In some examples, the reactive and/or proactive NBA workflow automation system 175b generates NBA automation workflows, where reactive NBA automation workflows react to existing or current issues, while proactive NBA automation workflows address predicted issues that have not yet affected (but likely would, if not addressed, affect) network service(s), network equipment, and/or CPE. The line health check system 175c checks the health of line services in the one or more networks 165 that provide the network services.

In some examples, the framework engine 110 checks whether the issues have been resolved based on analysis of the current network data obtained from the data repository 120 and/or based on health check data obtained from the line health check system 175c, via the DaaS system 130. Although DaaS system 130 is used as an intermediary between the framework engine 110 and the automation workflow engine 175 in this example, in other examples, the framework engine 110 may interact directly with the automation workflow engine 175. Based on either a determination that the NBAs cannot be performed using an automation workflow or a determination that the NBA automation workflows have not resolved the identified issue(s), the framework engine 110 generates and sends a first message to a user (e.g., a customer, an agent, and/or a technician, etc.) by sending to the user's device(s) (e.g., customer device(s) 195, agent device(s) 190, technician device(s) 185, and/or the like), via APIs 135 and via API gateway 180 or via dashboard UI 175a (in the case of the technician device(s) 185). The first message may be displayed in the respective apps (e.g., customer app(s) 195a, agent app(s) 190a, technician app(s) 185a, etc.) that may be displayed in a display screen of the user's device(s). In examples, the first message may include information regarding the identified issue(s), an indication that the identified issue(s) is yet to be resolved, and a list of remaining NBAs among the one or more NBAs. Based on a determination that the identified issue(s) has been resolved, the framework engine 110 generates and sends a second message to the user or user device in a similar manner as the first message. In some examples, the second message includes the information regarding the identified issue(s) and an indication that the identified issue(s) was identified and has been resolved. In a similar manner, an E2E circuit view may be generated and sent to the user device via APIs 135 and via API gateway 180 or via dashboard UI 175a (in the case of the technician device(s) 185).

In some examples, the NBAs may include NBAs to address network issues, NBAs to address Wi-Fi issues, NBAs to address LAN issues, and/or the like. The NBAs to address network issues may include checking low network performers (e.g., network equipment having sub-par rates), checking line stability, checking synchronization issues, checking fiber health of optical network systems, checking for subpar WAN Ethernet port rates, checking gateway compatibility with access network technology, checking a purchased speed for a customer's service, checking whether broadband latency has been too high (e.g. for interactive applications like VoIP or online gaming, etc.), performing a walled garden check, performing an authentication check, checking whether downstream speeds are too low for expected services (e.g., due to game streaming, etc.), checking for subpar speed tests from a modem(s), and/or the like. The NBAs to address Wi-Fi issues may include checking for improper Wi-Fi settings, checking for interference problems, checking whether a number of connected devices has been reaching the maximum limit of the network, checking whether the Wi-Fi network is disabled, verifying that Wi-Fi security settings are optimal, checking for whether legacy devices are detected on the Wi-Fi network, checking whether wireless broadcast is disabled, and/or the like. The NBAs to address LAN issues may include checking whether no devices are connected to a network, checking whether there are no devices connected to the 2.4 GHz or the 5 GHz Wi-Fi bands, checking for sub-optimal Ethernet ports, checking whether network address translation (“NAT”) settings in the modem is enabled, checking whether a server for LAN device management and dynamic host configuration protocol (“DHCP”) is disabled, checking whether a filter for LAN device management and MAC address is enabled, and/or the like. Although particular NBAs are described above, other NBAs may additionally or alternatively be generated and/or used.

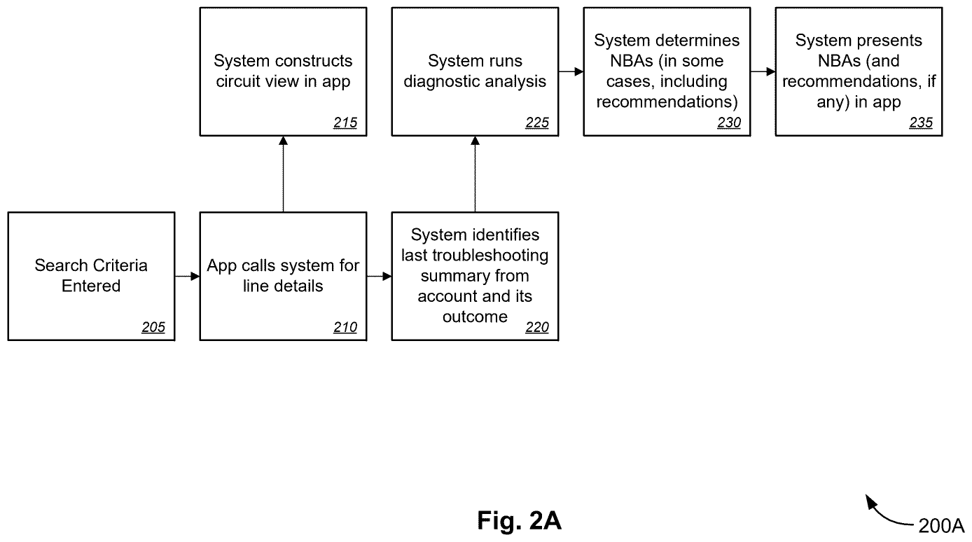

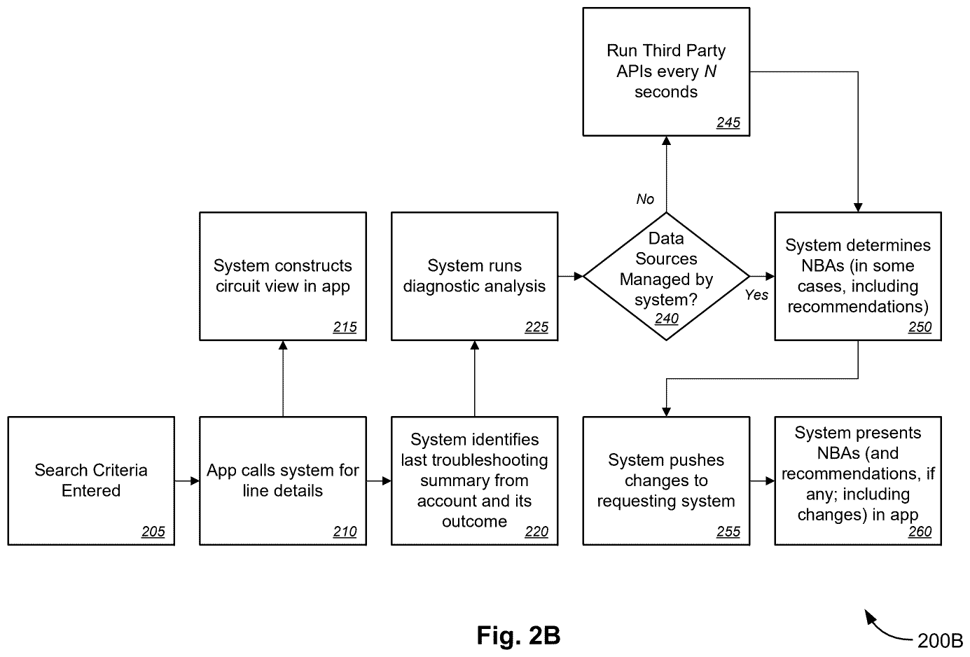

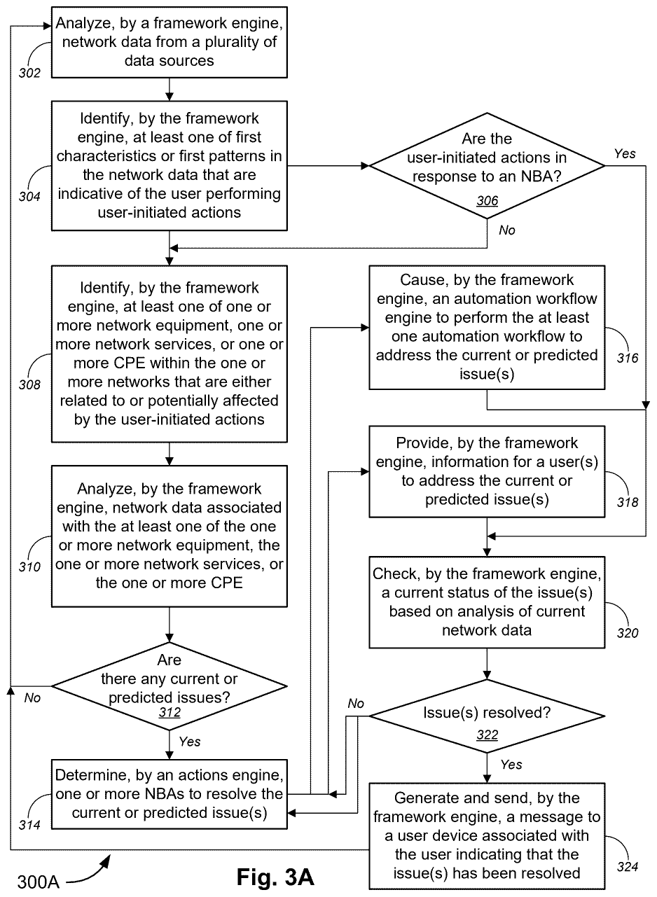

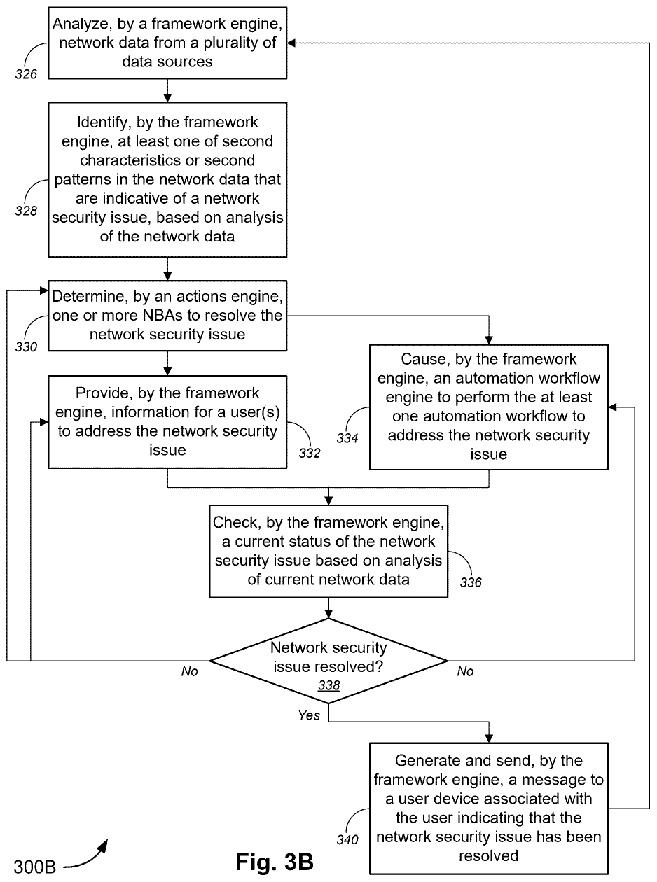

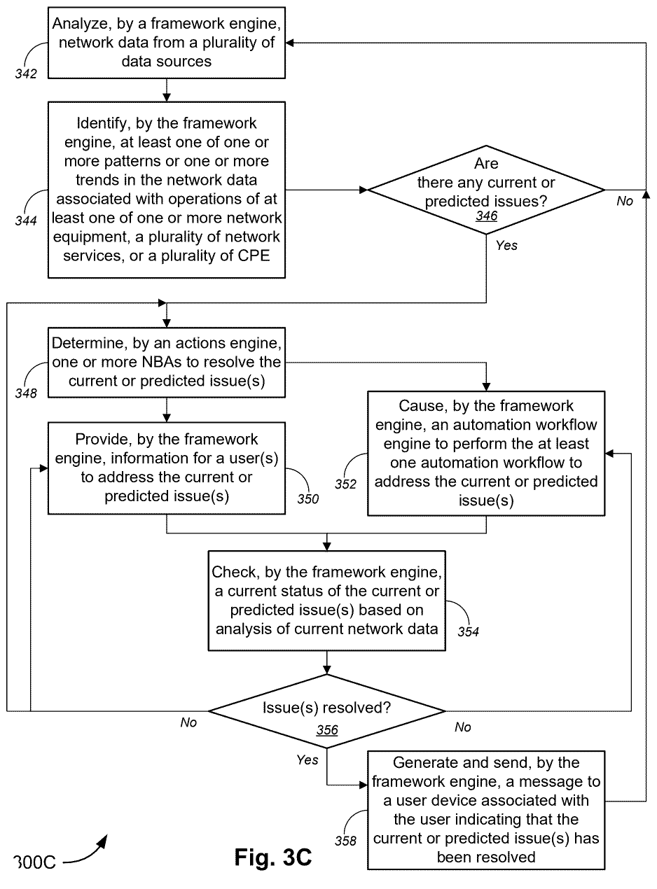

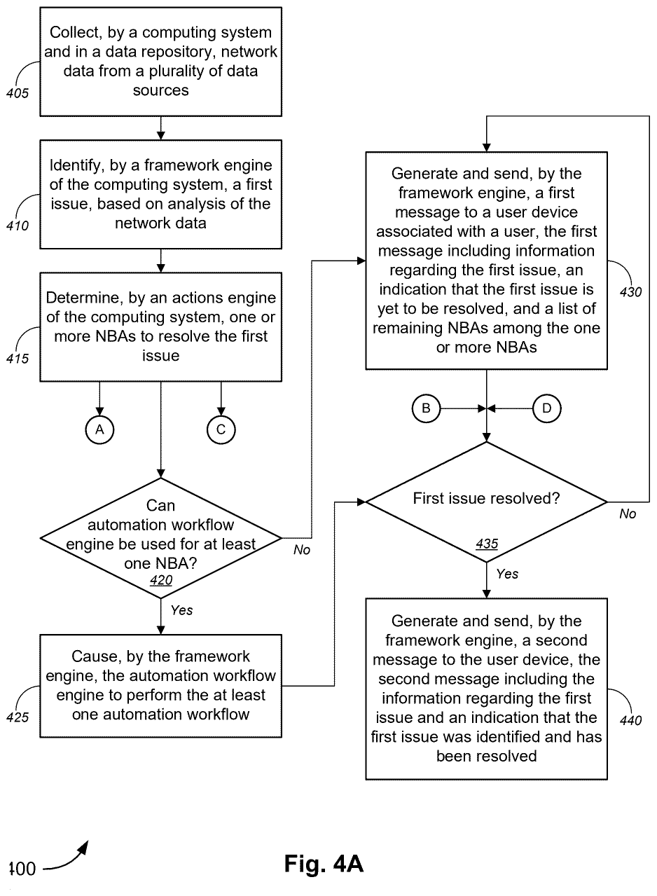

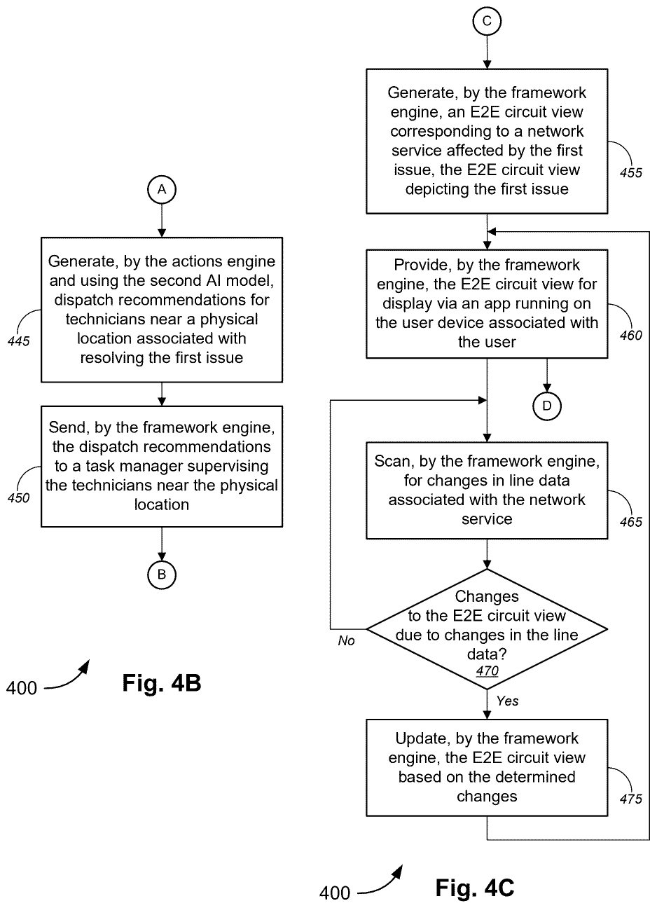

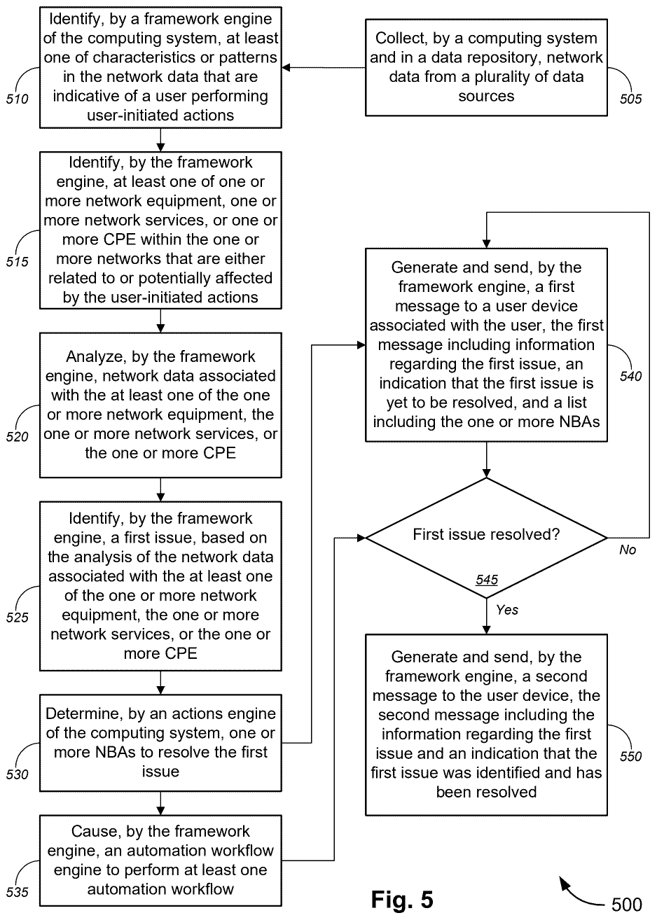

In operation, computing system 105, framework engine 110, and/or actions engine 115 may perform methods for implementing automated diagnostic and predictive troubleshooting, as described in detail with respect to FIGS. 2-5. For example, example sequence flows 200A, 200B, 300A, 300B, and 300C as described below with respect to FIGS. 2A, 2B, 3A, 3B, and 3C, respectively, example methods 400 and 500 as described below with respect to FIG. 4A-4C and 5 may be applied with respect to the operations of system 100 of FIG. 1.

FIGS. 2A and 2B (collectively, “FIG. 2”) depict example sequence flows 200A and 200B for obtaining data via a pull model and via a push model, respectively, when implementing automated diagnostic and predictive troubleshooting, in accordance with various embodiments.

With reference to FIG. 2A, example sequence flow 200A corresponds to a pull model in which a requesting device (e.g., technician device(s) 185, agent device(s) 190, or customer device(s) 195 of FIG. 1, or the like) requests or pulls results of a computing system that performs automated diagnostic and predictive troubleshooting (such as computing system 105 of FIG. 1, or the like). In examples, the results include information regarding any identified issues associated with network service provided by a service provider to a customer, NBAs, and/or recommendations, and/or the like. The NBAs as described with respect to sequence flows 200A and 200B may include at least some of the NBAs described above with respect to FIG. 1.

At operation 205, search criteria is entered by a user (e.g., a technician(s), an agent of the service provider, or a customer), in some cases, via an app (e.g., technician app(s) 185a, agent app(s) 190a, or customer app(s) 195a of FIG. 1, or the like) that is running on the requesting device. In some examples, search criteria may include a destination telephone number (“DTN”), an email address, a physical address, a serial number of a gateway device (e.g., a residential gateway (“RG”) device, a commercial gateway device, etc.), a full service access network (“FSAN”) identifier, a media access control (“MAC”) address, customer name, etc.

At operation 210, the app calls the system (e.g., computing system 105 of FIG. 1, or the like) for line details associated with the network service provided to the customer, via an API(s) (e.g., API(s) 135 via API gateway 180 of FIG. 1, or the like). That is, the app initiates an API call to the system to request the line details. In examples, the line details may include customer account information, billing information associated with the customer, line information, information regarding an associated optical network terminal (“ONT”), information regarding an associated digital subscriber line access multiplexer (“DSLAM”), information regarding the gateway device, test history, account usage profile (e.g., whether the customer is a gamer, a streamer, etc. ; whether the customer uses a mobile device that is IOS based or Android based; etc.), and/or the like.

At operation 215, the system constructs a circuit view corresponding to the network service provided to the customer and/or the line details (which are requested at operation 210). In some instances, the circuit view also depicts any issues identified by the system for the network service. At operation 220, the system identifies the last troubleshooting summary (or last M-number of troubleshooting summaries, where M is any suitable positive integer number) for a customer account associated with the network service, as well as identifying an outcome for the last troubleshooting summary (or for each troubleshooting summary that is identified).

At operation 225, the system (such as framework engine 110, actions engine 115, and/or DaaS system 130 of computing system 105 of FIG. 1, or the like) runs diagnostic analysis of network data (such as network data described in detail above with respect to FIG. 1, or the like) that is associated with the line details, in some cases, using an AI system (e.g., AI system 125 of FIG. 1). In some examples, running the diagnostic analysis (at operation 225) includes using real-time (or near-real-time) data from additional systems and providing real-time as well as historical statistics, statuses, and/or measurements for local area network (“LAN”) devices, Wi-Fi access point (“AP”) devices, network speed tests, network data traffic congestion, and/or bandwidth usage, and/or the like that are associated with the line details.

At operation 230, the system (such as actions engine 115 of computing system 105 of FIG. 1, or the like) determines one or more NBAs, in some cases, using the AI system. In some examples, each NBA includes at least one of a summary description of an action designed to resolve an issue(s) with the network service, a step-by-step textual guidance for performing that action, a step-by-step audio guidance for performing that action, a step-by-step static image-based guidance for performing that action, a step-by-step video guidance for performing that action, or an AI generated guidance for performing that action, and/or the like. In some examples, the system also generates recommendations either corresponding to and/or supplemental to the one or more NBAs. In examples, recommendations may include dispatch recommendations for technicians to attempt resolving the issue(s) in the field (e.g., at a customer premises, at a central office location, at a location of network equipment (e.g., that is located between the central office location and the customer premises, that is located at a core network location, that is located at a data center, etc.)). At operation 235, the system presents the one or more NBAs (and recommendations, if any) in the app, which is displayed on a display device of the requesting device.

In examples, the AI system uses a first AI model to analyze network data to identify any issues with the network service and uses a second AI model to determine the one or more NBAs, to generate recommendations corresponding to and/or supplemental to the one or more NBAs, and to generate the dispatch recommendations for technicians associated with resolving the issue(s). In some examples, the first AI model is trained to perform at least one of correlating a set of network data to identify patterns and trends in the set of network data, analyzing the set of network data to identify and troubleshoot issues based on the analysis of the set of network data, or utilizing automated diagnostic tools to identify root causes of the issues, and/or the like.

Referring to FIG. 2B, example sequence flow 200B corresponds to a push model in which, like the pull model of FIG. 2A, a requesting device requests or pulls results of a computing system that performs automated diagnostic and predictive troubleshooting, but, unlike the pull model of FIG. 2A, any changes to the NBAs and/or the recommendations are pushed to the requesting system. As shown in FIG. 2B, the push model begins in a similar manner as the pull model of FIG. 2A, with the processes at operations 205 through 225 being similar, if not identical. After the process at operation 225, sequence flow 200B further includes the system determining whether data sources, from which at least some of the network data that is used for the diagnostic analysis are obtained, are managed by the system (at operation 240). For data sources that are not managed by the system, at operation 245, the system runs third party APIs every N-number of seconds (where N is any suitable positive integer number, e.g., 30 seconds or the like) to obtain the data from third party data sources (referred to herein as “third-party-managed data sources”). Examples of such third party data may include commercial power outage data, weather data, home square footage data, and/or the like. For data sources that are managed by the system (referred to herein as “system-managed data sources”), at operation 250, the system determines the one or more NBAs (in some cases, including the recommendations), based on the data obtained from the system-managed data sources. Alternatively or additionally, also at operation 250, the system determines the one or more NBAs and/or recommendations, based on the data obtained every N-number of seconds from the third-party-managed data sources. Following operation 250, the system identifies changes to the NBAs and/or the recommendations and pushes the identified changes to the requesting system (at operation 255). After pushing the changes (at operation 255), the system presents, in the app, the one or more NBAs as well as recommendations, if any, including any changes (at operation 260).

FIGS. 3A-3C (collectively, “FIG. 3”) depict various example sequence flows 300A-300C corresponding to various example implementations for automated diagnostic and predictive troubleshooting, in accordance with various embodiments. The operations of example sequence flows 300A-300C may be performed by a framework engine (e.g., framework engine 110 of FIG. 1) and an actions engine (e.g., actions engine 115 of FIG. 1), based on network data (such as network data described in detail above with respect to FIG. 1, or the like) that are obtained from a plurality of data sources (e.g., RTO system 140, pull-based data source(s) 170a, push-based data source(s) 170b, and/or third party data source(s) 170c of FIG. 1). The NBAs as described with respect to sequence flows 300A-300C may include at least some of the NBAs described above with respect to FIG. 1.

With reference to FIG. 3A, example sequence flow 300A corresponds to a user action example. At operation 302, sequence flow 300A includes a framework engine analyzing network data from a plurality of data sources. In examples, the network data may include near-real-time data and historical data associated with at least network equipment, network services, and CPE within one or more networks (e.g., the plurality of network equipment 160a-160z, the plurality of network services 155a-155y, and the plurality of CPE 150a-150x in network(s) 165 of FIG. 1).

At operation 304, the framework engine identifies at least one of first characteristics or first patterns in the network data that are indicative of the user performing user-initiated actions. At operation 306, the framework engine determines whether the user-initiated actions are in response to an NBA. Based on a determination that the user-initiated actions are not in response to an NBA, sequence flow 300A continues onto the process at operation 308. Based on a determination that the user-initiated actions are in response to an NBA(s), sequence flow 300A continues onto the process at operation 320.

At operation 308, the framework engine identifies at least one of one or more network equipment, one or more network services, or one or more CPE within the one or more networks that are either related to or potentially affected by the user-initiated actions. At operation 310, the framework engine analyzes network data associated with the at least one of the one or more network equipment, the one or more network services, or the one or more CPE. At operation 312, the framework engine determines whether there are any current or predicted issues based on the analysis (from operation 310). Based on a determination that there are no current or predicted issues, sequence flow 300A returns to the process at operation 302. Based on a determination that there is a current or predicted issue(s), sequence flow 300A continues onto the process at operation 314. As used herein, a current issue is an issue that is currently affecting at least one of a network equipment, a network service(s), and/or a CPE, while a predicted issue is an issue that has not yet affected any network equipment, network service, or CPE, but there are signs or indications of a likelihood (e.g., probability above a threshold probability, such as above 50 %) that said issue may affect at least one network equipment, at least one network service, and/or at least one CPE.

At operation 314, an actions engine determines one or more NBAs to resolve the current or predicted issue(s). In some examples, sequence flow 300A may continue from the process at operation 314 either onto the process at operation 316 or onto the process at operation 318. At operation 316, the framework engine causes an automation workflow engine (e.g., automation workflow engine 175 of FIG. 1) to perform the at least one automation workflow, with the automation workflow engine generating and using automated scripts tailored to at least partially resolve the current or predicted issue(s) while performing the at least one automation workflow. At operation 318, the framework engine provides information for a user(s) to address the current or predicted issue(s). In examples, the information provided may include information regarding the current or predicted issue(s), an indication that the current or predicted issue(s) is yet to be resolved, and a list of the one or more NBAs (or remaining NBAs if some of the NBAs have already been performed and/or attempted). Following each of the processes at operations 316 and 318, sequence flow 300A continues onto the process at operation 320.

At operation 320, the framework engine checks a current status of the current or predicted issue(s), in some cases, based on analysis of current network data. At operation 322, the framework engine determines whether the current or predicted issue(s) has been resolved, in some cases, based on the current status check (from operation 320). Based on a determination that the current or predicted issue(s) has not been resolved, sequence flow 300A returns to one of: the process at operation 314, the process at operation 316, or the process at operation 318. Based on a determination that the current or predicted issue(s) has been resolved, the framework engine generates and sends a message to the user device indicating that the current or predicted issue(s) has been resolved (at operation 324). In some examples, sequence flow 300A may return to the process at operation 302 to continue repeating the processes at operations 302-324.

In examples, the user-initiated actions may include one of customer-initiated troubleshooting actions, technician-initiated actions in a field location, or installation and connection of network equipment to the one or more networks, or the like. In an example, the customer-initiated troubleshooting actions may include the customer running a speed test, then using a voice portal to contact an agent of the service provider, and then speaking with the agent. The data associated the underlying systems corresponding to each of these actions is stored in the data stores and is collected into a data repository (e.g., data repository 120 of FIG. 1, or the like) from these data stores by the system, and the framework engine accesses the data from the data repository. In another example, the customer-initiated troubleshooting actions may include the customer running a speed test multiple times, then rebooting their device. Before the customer contacts an agent of the service provider, the system proactively identifies and correlates these actions, and runs through the sequence flow 300A to identify any issues in the service line providing network service to the customer, and, if any issues are identified, to determine NBAs and to initiate resolution actions, as described above with respect to the processes at operations 302-324. The system then proactively reaches out to the customer regarding steps taken and to be taken (if any) to address the potential issue.

In yet another example, technician-initiated actions in a field location may include a technician changing connections to provision a new service. The system can identify whether the ports being reconnected are currently being used for provisioning another service or if there are line issues associated with connecting to that port, and may provide NBAs and/or automated workflows to address the line issues (if any) or to use a different set of connections/ports. In another example, installation and connection of network equipment to one or more networks may include a technician attempting to install an ONT at a first customer premises, encountering an issue, calling a programmer to correct the issue, etc. The system identifies the installation attempt and correlates the subsequent actions, and provides NBAs and/or an automated workflow for either correcting the issue before subsequent ONTs are deployed or pushing updates to ONTs being deployed and installed to address the issue, thereby obviating ad hoc calls to a programmer for each subsequent installation attempt. In some examples, the process for deployment, installation, and activation of ONTs may also be streamlined or optimized by the system in a similar manner, based on network data for previously activated ONTs.

In still another example, installation and connection of network equipment to one or more networks may include tracking an order for network equipment at location A, observing installation of the network equipment at location B, and tracking subsequent orders for the network equipment for location A. The system can identify the network equipment needs, installations, and orders, and can provide NBAs and/or automated workflows to address the issues (e.g., determining how much more equipment and which type of equipment is needed at both locations, initiating orders based on the determination, and causing sending of the correct network equipment to the correct locations, etc.).

Referring to FIG. 3B, example sequence flow 300B corresponds to a network security example. At operation 326, sequence flow 300B includes a framework engine analyzing network data from a plurality of data sources, similar to operation 302 in FIG. 3A. In examples, the network data may include near-real-time data and historical data associated with at least network equipment, network services, and CPE within one or more networks. At operation 328, the framework engine identifies at least one of second characteristics or second patterns in the network data that are indicative of a network security issue, based on analysis of the network data. In examples, the network security issue includes at least one of a security threat, presence of malware, an unauthorized attempt to access the one or more networks, an unknown device attempting to connect to the one or more networks, or a distributed denial of service (“DDoS”) attack, and/or the like.

At operation 330, an actions engine determines one or more NBAs to resolve the network security issue. In some examples, sequence flow 300B may continue from the process at operation 330 either onto the process at operation 332 or onto the process at operation 334. At operation 332, the framework engine provides information for a user(s) to address the network security issue. In examples, the information provided may include information regarding the network security issue, an indication that the network security issue is yet to be resolved, and a list of the one or more NBAs (or remaining NBAs if some of the NBAs have already been performed and/or attempted). At operation 334, the framework engine causes an automation workflow engine to perform the at least one automation workflow, with the automation workflow engine generating and using automated scripts tailored to at least partially resolve the network security issue while performing the at least one automation workflow. Following each of the processes at operations 332 and 334, sequence flow 300B continues onto the process at operation 336.

At operation 336, the framework engine checks a current status of the network security issue, in some cases, based on analysis of current network data. At operation 338, the framework engine determines whether the network security issue has been resolved, in some cases, based on the current status check (from operation 336). Based on a determination that the network security issue has not been resolved, sequence flow 300B returns to one of: the process at operation 330, the process at operation 332, or the process at operation 334. Based on a determination that the network security issue has been resolved, the framework engine generates and sends a message to the user device indicating that the network security issue has been resolved (at operation 340). In some examples, sequence flow 300B may return to the process at operation 326 to continue repeating the processes at operations 326-340.

Turning to FIG. 3C, example sequence flow 300C corresponds to a patterns and trends example. At operation 342, sequence flow 300C includes a framework engine analyzing network data from a plurality of data sources, similar to operation 302 in FIG. 3A. In examples, the network data may include near-real-time data and historical data associated with at least network equipment, network services, and CPE within one or more networks. At operation 344, the framework engine identifies at least one of one or more patterns and/or one or more trends in the network data associated with operations of at least one of one or more network equipment associated with providing a plurality of network services, the plurality of network services, or a plurality of CPE associated with the plurality of network services, based on analysis of the network data associated with the plurality of network services. At operation 346, the framework engine determines whether there are any current or predicted issues based on the analysis (from operation(s) 342 and/or 344). Based on a determination that there are no current or predicted issues, sequence flow 300C returns to the process at operation 342. Based on a determination that there is a current or predicted issue(s), sequence flow 300C continues onto the process at operation 348.

In examples, the current or predicted issue(s) may include one or more of:
(1) efficiency issues including suboptimal or inefficient operations of the at least one of the one or more network equipment, the plurality of network services, or the plurality of CPE;
(2) utilization issues including one of over or under-utilization of the at least one of the one or more network equipment, the plurality of network services, or the plurality of CPE;
(3) network issues including at least one of latency issues, traffic congestion issues, or connectivity issues associated with the at least one of the one or more network equipment, the plurality of network services, or the plurality of CPE; or
(4) errors including at least one of system lock-up occurrences, abnormal behaviors, commonly observed errors, a number of restarts exceeding a threshold number, incompatible updates, or other failures; and/or the like.

At operation 348, an actions engine determines one or more NBAs to resolve the current or predicted issue(s). In some examples, sequence flow 300C may continue from the process at operation 348 either onto the process at operation 350 or onto the process at operation 352. At operation 350, the framework engine provides information for a user(s) to address the current or predicted issue(s). In examples, the information provided may include information regarding the current or predicted issue(s), an indication that the current or predicted issue(s) is yet to be resolved, and a list of the one or more NBAs (or remaining NBAs if some of the NBAs have already been performed and/or attempted). At operation 352, the framework engine causes an automation workflow engine to perform the at least one automation workflow, with the automation workflow engine generating and using automated scripts tailored to at least partially resolve the current or predicted issue(s) while performing the at least one automation workflow. Following each of the processes at operations 350 and 352, sequence flow 300C continues onto the process at operation 354.

At operation 354, the framework engine checks a current status of the current or predicted issue(s), in some cases, based on analysis of current network data. At operation 356, the framework engine determines whether the current or predicted issue(s) has been resolved, in some cases, based on the current status check (from operation 354). Based on a determination that the current or predicted issue(s) has not been resolved, sequence flow 300C returns to one of: the process at operation 348, the process at operation 350, or the process at operation 352. Based on a determination that the current or predicted issue(s) has been resolved, the framework engine generates and sends a message to the user device indicating that the current or predicted issue(s) has been resolved (at operation 358). In some examples, sequence flow 300C may return to the process at operation 342 to continue repeating the processes at operations 342-358.

FIGS. 4A-4C (collectively, “FIG. 4”) depict flow diagrams illustrating an example method 400 for implementing automated diagnostic and predictive troubleshooting, in accordance with various embodiments. The operations of example method 400 may be performed by a computing system (e.g., computing system 105 of FIG. 1), a framework engine of the computing system (e.g., framework engine 110 of FIG. 1), and/or an actions engine of the computing system (e.g., actions engine 115 of FIG. 1). Method 400 of FIG. 4A continues onto FIG. 4B following the circular marker denoted, “A,” and returns to FIG. 4A following the circular marker denoted, “B.” Method 400 of FIG. 4A continues onto FIG. 4C following the circular marker denoted, “C,” and returns to FIG. 4A following the circular marker denoted, “D.” The NBAs as described with respect to method 400 may include at least some of the NBAs described above with respect to FIG. 1.

In the non-limiting embodiment of FIG. 4A, method 400, at operation 405, may include a computing system collecting, in a data repository (e.g., data repository 120 of FIG. 1), network data (such as network data described in detail above with respect to FIG. 1, or the like) from a plurality of data sources (e.g., RTO system 140, pull-based data source(s) 170a, push-based data source(s) 170b, and/or third party data source(s) 170c of FIG. 1). In examples, the network data may include near-real-time data and historical data associated with at least network equipment, network services, and CPE within one or more networks (e.g., the plurality of network equipment 160a-160z, the plurality of network services 155a-155y, and the plurality of CPE 150a-150x in network(s) 165 of FIG. 1).

At operation 410, a framework engine of the computing system identifies a first issue associated with at least one of one or more network equipment, one or more network services, or one or more CPE being provided within the one or more networks, based on analysis of the network data. In some instances, the first issue is one of a current issue or a predicted issue. At operation 415, an actions engine of the computing system determines one or more NBAs to resolve the first issue. In some examples, method 400 may continue from the process at operation 415 onto the process at operation 420. In other examples, method 400 may continue onto the process at operation 445 in FIG. 4B following the circular marker denoted, “A,” before returning to the process at operation 435 in FIG. 4A, as indicated by the circular marker denoted, “B.” In yet other examples, method 400 may continue onto the process at operation 455 in FIG. 4C following the circular marker denoted, “C,” before returning to the process at operation 435 in FIG. 4A, as indicated by the circular marker denoted, “D.”

At operation 420, the framework engine determines whether at least one NBA among the one or more NBAs can be performed using an automation workflow engine (e.g., automation workflow engine 175 of FIG. 1). Based on a determination that at least one NBA among the one or more NBAs can be performed using at least one automation workflow, method 400 continues onto the process at operation 425. Based on a determination that NBAs cannot be performed using an automation workflow, method 400 continues onto the process at operation 430. At operation 425, the framework engine causes the automation workflow engine to perform the at least one automation workflow, with the automation workflow engine generating and using automated scripts tailored to at least partially resolve the first issue while performing the at least one automation workflow. Method 400 continues onto the process at operation 435.

At operation 430, the framework engine generates and sends a first message to a user device associated with a user, the first message including information regarding the first issue, an indication that the first issue is yet to be resolved, and a list of remaining NBAs among the one or more NBAs. At operation 435, the framework engine determines whether the first issue has been resolved, in some cases, based on analysis of current network data. Based on a determination that the first issue has not been resolved, method 400 returns to the process at operation 430. Based on a determination that the first issue has been resolved, the framework engine generates and sends a second message to the user device, the second message including the information regarding the first issue and an indication that the first issue was identified and has been resolved (at operation 440).

In examples, analysis of the network data may be performed using a first AI model that is trained to perform at least one of correlating a set of network data to identify patterns and trends in the set of network data, analyzing the set of network data to identify and troubleshoot network issues based on the analysis of the set of network data, or utilizing automated diagnostic tools to identify root causes of the network issues. In such cases, identifying the first issue (at operation 410) includes the framework engine identifying, using the first AI model, the first issue based on the analysis of the network data. In some examples, determining the one or more NBAs (at operation 415) includes the actions engine determining, using a second AI model, the one or more NBAs.

At operation 445 in FIG. 4B (following the circular marker denoted, “A,” in FIG. 4A), method 400 may include the actions engine generating, using the second AI model, dispatch recommendations for technicians near a physical location associated with resolving the first issue. At operation 450, the framework engine sends the dispatch recommendations to a task manager supervising the technicians near the physical location. The task manager assigns and dispatches technicians for repair and/or installation tasks (sometimes referred to as “truck rolls’) in the field, and can use the dispatch recommendations to do so. Method 400 returns to the process at operation 435 in FIG. 4A following the circular marker denoted, “B.”

At operation 455 in FIG. 4C (following the circular marker denoted, “C,” in FIG. 4A), method 400 may include the framework engine generating an E2E circuit view corresponding to a network service affected by the first issue, the E2E circuit view depicting the first issue. At operation 460, the framework engine provides the E2E circuit view for display via an app running on the user device associated with the user. Method 400 either may continue onto the process at operation 465 or may return to the process at operation 435 in FIG. 4A following the circular marker denoted, “D.”

At operation 465, the framework engine scans for changes in line data associated with the network service. At operation 470, the framework engine determines whether there are changes to the E2E circuit view based on changes in the line data. Based on a determination that there are no changes to the E2E circuit view, method 400 returns to the process at operation 465. Based on a determination that there are changes to the E2E circuit view, method 400 continues onto the process at operation 475. At operation 475, the framework engine updates the E2E circuit view based on the determined changes (from operation 470). Method returns to the process at operation 460.

FIG. 5 depicts a flow diagram illustrating another example method 500 for implementing automated diagnostic and predictive troubleshooting, in accordance with various embodiments. The operations of example method 500 may be performed by a computing system (e.g., computing system 105 of FIG. 1), a framework engine of the computing system (e.g., framework engine 110 of FIG. 1), and/or an actions engine of the computing system (e.g., actions engine 115 of FIG. 1). The NBAs as described with respect to method 500 may include at least some of the NBAs described above with respect to FIG. 1.

In the non-limiting embodiment of FIG. 5, method 500, at operation 505, may include a computing system collecting, in a data repository (e.g., data repository 120 of FIG. 1), network data (such as network data described in detail above with respect to FIG. 1, or the like) from a plurality of data sources (as described in detail above). At operation 510, a framework engine of the computing system identifies at least one of characteristics or patterns in the network data that are indicative of a user performing user-initiated actions. In examples, the network data may include near-real-time data and historical data associated with at least network equipment, network services, and CPE within one or more networks (e.g., the plurality of network equipment 160a-160z, the plurality of network services 155a-155y, and the plurality of CPE 150a-150x in network(s) 165 of FIG. 1). In some examples, the user-initiated actions may include one of customer-initiated troubleshooting actions, technician-initiated actions in a field location, or installation and connection of network equipment to the one or more networks, and/or the like.

At operation 515, the framework engine identifies at least one of one or more network equipment, one or more network services, or one or more CPE within the one or more networks that are either related to or potentially affected by the user-initiated actions. At operation 520, the framework engine analyzes network data associated with the at least one of the one or more network equipment, the one or more network services, or the one or more CPE that are either related to or potentially affected by the user-initiated actions. The framework engine identifies, at operation 525, a first issue based on the analysis of the network data associated with the at least one of the one or more network equipment, the one or more network services, or the one or more CPE.

At operation 530, an actions engine of the computing system determines one or more NBAs to resolve the first issue. Method 500 either may continue onto the process at operation 535 and/or may continue onto the process at operation 540, with the framework engine performs at least one of: (i) causing an automation workflow engine (e.g., automation workflow engine 175 of FIG. 1) to perform at least one automation workflow as part of the one or more NBAs (at operation 535); and/or (ii) generating and sending a first message to the user device, the first message including information regarding the first issue, an indication that the first issue is yet to be resolved, and a list including the one or more NBAs (at operation 540). Following each of the processes at operations 535 and 540, method 500 continues onto the process at operation 545. At operation 545, the framework engine determines whether the first issue has been resolved, in some cases, based on analysis of current network data associated with the at least one of the one or more network equipment, the one or more network services, or the one or more CPE (such as at operation 520). Based on a determination that the first issue has not been resolved, method 500 returns to the process at operation 540. Based on a determination that the first issue has been resolved, the framework engine generates and sends a second message to the user device, the second message including the information regarding the first issue and an indication that the first issue was identified and has been resolved (at operation 550).

While the techniques and procedures in sequence flows or methods 200A, 200B, 300A, 300B, 300C, 400, and 500 are depicted and/or described in a certain order for purposes of illustration, it should be appreciated that certain procedures may be reordered and/or omitted within the scope of various embodiments. Moreover, while the methods 200A, 200B, 300A, 300B, 300C, 400, and 500 may be implemented by or with (and, in some cases, are described below with respect to) the system(s), example(s), or embodiment(s) 100 of FIG. 1 (or components thereof), such methods may also be implemented using any suitable hardware (or software) implementation. Similarly, while each of the system(s), example(s), or embodiment(s) 100 of FIG. 1 (or components thereof), can operate according to the methods 200A, 200B, 300A, 300B, 300C, 400, and 500 (e.g., by executing instructions embodied on a computer readable medium), the system(s), example(s), or embodiment(s) 100 of FIG. 1 can each also operate according to other modes of operation and/or perform other suitable procedures.

### Exemplary System and Hardware Implementation

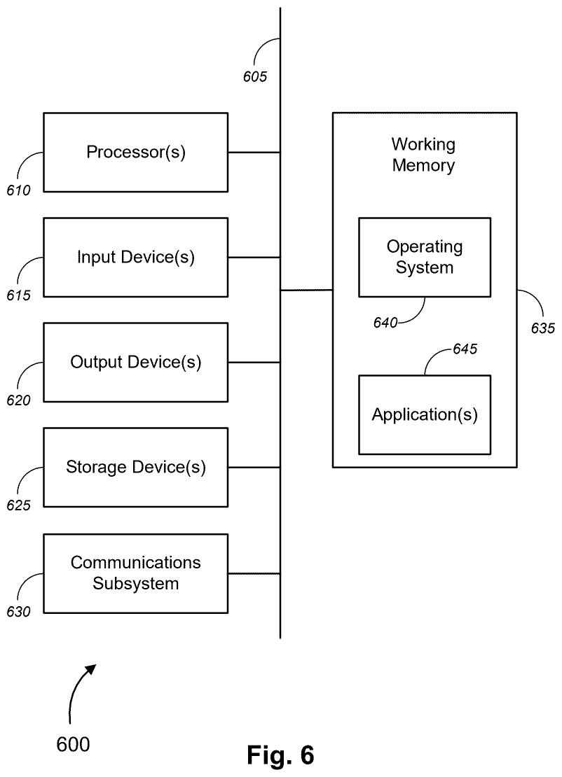

FIG. 6 is a block diagram illustrating an exemplary computer or system hardware architecture, in accordance with various embodiments. FIG. 6 provides a schematic illustration of one embodiment of a computer system 600 of the service provider system hardware that can perform the methods provided by various other embodiments, as described herein, and/or can perform the functions of computer or hardware system (i.e., the computing system 105, the framework engine 110, the actions engine 115, the AI system 125, the DaaS system 130, the RTO system 140, the AI/ML system 140a, the plurality of CPE 150a-150x, the plurality of network services 155a-155y, the plurality of network equipment 160a-160z, the automation workflow engine 175, the API gateway 180, the technician device(s) 185, the agent device(s) 190, and the customer device(s) 195, etc.), as described above. It should be noted that FIG. 6 is meant only to provide a generalized illustration of various components, of which one or more (or none) of each may be utilized as appropriate. FIG. 6, therefore, broadly illustrates how individual system elements may be implemented in a relatively separated or relatively more integrated manner.

The computer or hardware system 600 - which might represent an embodiment of the computer or hardware system (i.e., the computing system 105, the framework engine 110, the actions engine 115, the AI system 125, the DaaS system 130, the RTO system 140, the AI/ML system 140a, the plurality of CPE 150a-150x, the plurality of network services 155a-155y, the plurality of network equipment 160a-160z, the automation workflow engine 175, the API gateway 180, the technician device(s) 185, the agent device(s) 190, and the customer device(s) 195, etc.), described above with respect to FIGS. 1-5—is shown including hardware elements that can be electrically coupled via a bus 605 (or may otherwise be in communication, as appropriate). The hardware elements may include one or more processors 610, including, without limitation, one or more general-purpose processors and/or one or more special-purpose processors (such as microprocessors, digital signal processing chips, graphics acceleration processors, and/or the like); one or more input devices 615, which can include, without limitation, a mouse, a keyboard, and/or the like; and one or more output devices 620, which can include, without limitation, a display device, a printer, and/or the like.

The computer or hardware system 600 may further include (and/or be in communication with) one or more storage devices 625, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 600 might also include a communications subsystem 630, which can include, without limitation, a modem, a network card (wireless or wired), an infrared communication device, a wireless communication device and/or chipset (such as a Bluetooth™ device, an 802.11 device, a Wi-Fi device, a WiMAX device, a wireless wide area network (“WWAN”) device, cellular communication facilities, etc.), and/or the like. The communications subsystem 630 may permit data to be exchanged with a network (such as the network described below, to name one example), with other computer or hardware systems, and/or with any other devices described herein. In many embodiments, the computer or hardware system 600 will further include a working memory 635, which can include a RAM or ROM device, as described above.

The computer or hardware system 600 also may include software elements, shown as being currently located within the working memory 635, including an operating system 640, device drivers, executable libraries, and/or other code, such as one or more application programs 645, which may include computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 625 described above. In some cases, the storage medium might be incorporated within a computer system, such as the system 600. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 600 and/or might take the form of source and/or installable code, which, upon compilation and/or installation on the computer or hardware system 600 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 600) to perform methods in accordance with various embodiments of the invention. According to a set of embodiments, some or all of the procedures of such methods are performed by the computer or hardware system 600 in response to processor 610 executing one or more sequences of one or more instructions (which might be incorporated into the operating system 640 and/or other code, such as an application program 645) contained in the working memory 635. Such instructions may be read into the working memory 635 from another computer readable medium, such as one or more of the storage device(s) 625. Merely by way of example, execution of the sequences of instructions contained in the working memory 635 might cause the processor(s) 610 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 600, various computer readable media might be involved in providing instructions/code to processor(s) 610 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 625. Volatile media includes, without limitation, dynamic memory, such as the working memory 635. In some alternative embodiments, a computer readable medium may take the form of transmission media, which includes, without limitation, coaxial cables, copper wire, and fiber optics, including the wires that include the bus 605, as well as the various components of the communication subsystem 630 (and/or the media by which the communications subsystem 630 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 600. These signals, which might be in the form of electromagnetic signals, acoustic signals, optical signals, and/or the like, are all examples of carrier waves on which instructions can be encoded, in accordance with various embodiments of the invention.

The communications subsystem 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a storage device 625 either before or after execution by the processor(s) 610.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
collecting, by a computing system and in a data repository, network data from a plurality of data sources, the network data including near-real-time data and historical data associated with at least network equipment, network services, and customer premises equipment (“CPE”) within one or more networks;
identifying, by a framework engine of the computing system, a first issue associated with at least one of one or more network equipment, one or more network services, or one or more CPE being provided within the one or more networks, based on analysis of the network data, wherein the first issue is one of a current issue or a predicted issue;
determining, by an actions engine of the computing system, one or more next best actions (“NBAs”) to resolve the first issue;
determining, by the framework engine, whether at least one NBA among the one or more NBAs can be performed using an automation workflow engine;
based on a determination that at least one NBA among the one or more NBAs can be performed using at least one automation workflow, causing, by the framework engine, the automation workflow engine to perform the at least one automation workflow, with the automation workflow engine generating and using automated scripts tailored to at least partially resolve the first issue;
based on either a determination that the one or more NBAs cannot be performed using an automation workflow or a determination that the at least one automation workflow has not resolved the first issue, generating and sending, by the framework engine, a first message to a user device associated with a user, the first message including information regarding the first issue, an indication that the first issue is yet to be resolved, and a list of remaining NBAs among the one or more NBAs; and
based on a determination that the first issue has been resolved, generating and sending, by the framework engine, a second message to the user device, the second message including the information regarding the first issue and an indication that the first issue was identified and has been resolved.

2. The method of claim 1, wherein each of the near-real-time data and the historical data includes at least one of status data, operational data, log data, connectivity data, failure data, equipment data, inventory data, network data, service data, customer service records, service location data, or end-to-end (“E2E”) network data, wherein the network data is pulled, pushed, or requested from the plurality of data sources.

3. The method of claim 1, wherein the plurality of data sources further includes a plurality of third party data sources, wherein the network data further includes external source data obtained from the plurality of third party data sources, wherein the external source data includes at least one of premises data associated with residential and commercial premises that are obtained from a real-estate marketplace platform, device manufacturer data associated with each network device connected to the one or more networks that are obtained from an organizational unique identifier (“OUI”) lookup database, Wi-Fi certification data for Wi-Fi devices connected to the one or more networks that are obtained from a Wi-Fi certification database, or modulation and coding scheme (“MCS”) data associated with wireless network devices connected to the one or more networks that are obtained from a MCS index, wherein the premises data includes at least one of dimension data, feature data, structural data, construction date data, location data, or neighborhood data associated with the residential and commercial premises, wherein the MCS data includes at least one a list of modulation schemes, a list of coding schemes, wireless device transmission capability data, or wireless device transmission characteristics and behavior.

4. The method of claim 1, wherein the plurality of data sources includes a real-time orchestration (“RTO”) system that collects real-time and historical data sent by a plurality of CPE within the one or more networks, and that uses a machine learning (“ML”) model to generate status and alert data based on the real-time and historical data sent by the plurality of CPE, wherein the near-real-time data and the historical data associated with the CPE include the status and alert data generated by the ML model of the RTO system.

5. The method of claim 1, wherein analysis of the network data is performed using a first artificial intelligence (“AI”) model that is trained to perform at least one of correlating a set of network data to identify patterns and trends in the set of network data, analyzing the set of network data to identify and troubleshoot network issues based on the analysis of the set of network data, or utilizing automated diagnostic tools to identify root causes of the network issues, wherein identifying the first issue includes identifying, by the framework engine and using the first AI model, the first issue based on the analysis of the network data.

6. The method of claim 5, wherein determining the one or more NBAs includes determining, by the actions engine and using a second AI model, the one or more NBAs.

7. The method of claim 6, further comprising:
generating, by the actions engine and using the second AI model, dispatch recommendations for technicians near a physical location associated with resolving the first issue; and
sending, by the framework engine, the dispatch recommendations to a task manager supervising the technicians near the physical location.

8. The method of claim 1, wherein the identifying the first issue is performed in response to a first application programming interface (“API”) call from a software application (“app”) running on the user device associated with the user, the first API call requesting line details for a first network service provided to a first customer, wherein the network data includes line data including at least one of data associated with one or more local area network (“LAN”) devices corresponding to the first network service, status data associated with a wireless access point (“WAP”) corresponding to the first network service, current real-time network speed test results corresponding to the first network service, a historical set of network speed test results corresponding to the first network service, current real-time network congestion data related to providing the first network service, a historical set of network congestion data related to providing the first network service, current real-time bandwidth usage corresponding to the first network service, or a historical set of bandwidth usage corresponding to the first network service, wherein the method further comprises:
identifying, by the framework engine, at least one previous troubleshooting summary associated with an account corresponding to the first network service, as well as outcomes of the at least one previous troubleshooting summary;
wherein determining the one or more NBAs includes determining, by the actions engine, the one or more NBAs based on the at least one previous troubleshooting summary, the outcomes of the at least one previous troubleshooting summary, and the line data.

9. The method of claim 8, further comprising:
generating, by the framework engine, an end-to-end (“E2E”) circuit view corresponding to the first network service, the E2E circuit view depicting the first issue; and
providing, by the framework engine, the E2E circuit view for display via the app running on the user device.

10. The method of claim 8, further comprising:
scanning, by the framework engine, for changes in the line data;
based on identification of changes in the line data, determining, by the actions engine, one or more updated NBAs based on the changes in the line data; and
based on a determination that the one or more updated NBAs have changed from the one or more NBAs, pushing, by the framework engine, one or more notifications to the app running on the user device, the one or more notifications including changes between the one or more NBAs and the one or more updated NBAs.

11. The method of claim 1, further comprising:
identifying, by the framework engine, at least one of first characteristics or first patterns in network data that are indicative of the user performing user-initiated actions, wherein the user-initiated actions include one of customer-initiated troubleshooting actions, technician-initiated actions in a field location, or installation and connection of network equipment to the one or more networks;
determining, by the framework engine, whether the user-initiated actions are in response to an NBA;
based on a determination that the user-initiated actions are not in response to an NBA, identifying, by the framework engine, at least one of one or more network equipment, one or more network services, or one or more CPE within the one or more networks that are either related to or potentially affected by the user-initiated actions; and
analyzing, by the framework engine, network data associated with the at least one of the one or more network equipment, the one or more network services, or the one or more CPE;
wherein identifying the first issue includes identifying, by the framework engine, the first issue based on the analysis of the network data associated with the at least one of the one or more network equipment, the one or more network services, or the one or more CPE.

12. The method of claim 1, further comprising:
identifying, by the framework engine, at least one of second characteristics or second patterns in network data that are indicative of a network security issue, based on analysis of the network data;
wherein identifying the first issue includes identifying, by the framework engine, the first issue based on the at least one of the second characteristics or the second patterns, wherein the network security issue includes at least one of a security threat, presence of malware, an unauthorized attempt to access the one or more networks, an unknown device attempting to connect to the one or more networks, or a distributed denial of service (“DDoS”) attack.

13. The method of claim 1, further comprising:
identifying, by the framework engine, at least one of one or more patterns or one or more trends associated with operations of at least one of one or more network equipment associated with providing a plurality of network services, the plurality of network services, or a plurality of CPE associated with the plurality of network services, based on analysis of the network data associated with the plurality of network services;
wherein identifying the first issue includes identifying, by the framework engine, the first issue based on the at least one of the one or more patterns and the one or more trends, wherein the first issue includes one or more of:
efficiency issues including suboptimal or inefficient operations of the at least one of the one or more network equipment, the plurality of network services, or the plurality of CPE;
utilization issues including one of over or under-utilization of the at least one of the one or more network equipment, the plurality of network services, or the plurality of CPE;
network issues including at least one of latency issues, traffic congestion issues, or connectivity issues associated with the at least one of the one or more network equipment, the plurality of network services, or the plurality of CPE; or
errors including at least one of system lock-up occurrences, abnormal behaviors, commonly observed errors, a number of restarts exceeding a threshold number, incompatible updates, or other failures.

14. The method of claim 1, wherein each NBA includes at least one of a summary description of an action designed to resolve the first issue, a step-by-step textual guidance for performing that action, a step-by-step audio guidance for performing that action, a step-by-step static image-based guidance for performing that action, a step-by-step video guidance for performing that action, or an AI generated guidance for performing that action.

15. The method of claim 1, wherein the network data further includes commands that are executed by frontend network systems.

16. The method of claim 1, wherein the user includes one or more users including at least one of a technician, a service provider agent, a customer, or an agent of the customer.

17. A system, comprising:
a data repository;
a framework engine; and
an actions engine;
wherein the system executes computer executable instructions that cause the system to perform operations comprising:
collecting, in the data repository, network data from a plurality of data sources, the network data including near-real-time data and historical data associated with at least network equipment, network services, and customer premises equipment (“CPE”) within one or more networks;
identifying, using the framework engine, a first issue associated with at least one of one or more network equipment, one or more network services, or one or more CPE being provided within the one or more networks, based on analysis of the network data, wherein the first issue is one of a current issue or a predicted issue;
determining, using the actions engine, one or more next best actions (“NBAs”) to resolve the first issue;
determining, using the framework engine, whether at least one NBA among the one or more NBAs can be performed using an automation workflow engine;
based on a determination that at least one NBA among the one or more NBAs can be performed using at least one automation workflow, causing, using the framework engine, the automation workflow engine to perform the at least one automation workflow, with the automation workflow engine generating and using automated scripts tailored to at least partially resolve the first issue;
based on either a determination that the one or more NBAs cannot be performed using an automation workflow or a determination that the at least one automation workflow has not resolved the first issue, generating and sending, using the framework engine, a first message to a user device associated with a user, the first message including information regarding the first issue, an indication that the first issue is yet to be resolved, and a list of remaining NBAs among the one or more NBAs; and
based on a determination that the first issue has been resolved, generating and sending, using the framework engine, a second message to the user device, the second message including the information regarding the first issue and an indication that the first issue was identified and has been resolved.

18. The system of claim 17, further comprising:
an artificial intelligence (“AI”) system that uses a first AI model to analyze the network data to identify the first issue and that uses a second AI model to determine the one or more NBAs and to generate dispatch recommendations for technicians associated with resolving the first issue, wherein the first AI model is trained to perform at least one of correlating a set of network data to identify patterns and trends in the set of network data, analyzing the set of network data to identify and troubleshoot network issues based on the analysis of the set of network data, or utilizing automated diagnostic tools to identify root causes of the network issues.

19. A method, comprising:
identifying, by a framework engine of a computing system, at least one of characteristics or patterns in network data that are indicative of a user performing user-initiated actions, the network data including near-real-time data and historical data associated with at least network equipment, network services, and customer premises equipment (“CPE”) within one or more networks;
identifying, by the framework engine, at least one of one or more network equipment, one or more network services, or one or more CPE within the one or more networks that are either related to or potentially affected by the user-initiated actions;
analyzing, by the framework engine, network data associated with the at least one of the one or more network equipment, the one or more network services, or the one or more CPE that are either related to or potentially affected by the user-initiated actions;
identifying, by the framework engine, a first issue based on the analysis of the network data associated with the at least one of the one or more network equipment, the one or more network services, or the one or more CPE;
determining, by an actions engine of the computing system, one or more next best actions (“NBAs”) to resolve the first issue;
performing at least one of:
causing, by the framework engine, an automation workflow engine to perform at least one automation workflow as part of the one or more NBAs; or
generating and sending, by the framework engine, a first message to a user device associated with the user, the first message including information regarding the first issue, an indication that the first issue is yet to be resolved, and a list including the one or more NBAs; and
based on a determination that the first issue has been resolved, generating and sending, by the framework engine, a second message to the user device, the second message including the information regarding the first issue and an indication that the first issue was identified and has been resolved.

20. The method of claim 19, wherein the network data is collected in a data repository by the computing system, wherein the user-initiated actions include one of customer-initiated troubleshooting actions, technician-initiated actions in a field location, or installation and connection of network equipment to the one or more networks.
